(19) United States
(12) Patent Application Publication
(10) Pub. No.: US 2005/0158146 A1
(43) Pub. Date: Jul. 21, 2005

(54) Method of preparing purified biologically active oligosaccharide libraries

(76) Inventors: Amor Yehudit, Jerusalem (IL); Ofer Markman, Rehovot (IL); Mirit Kolog Gulko, Rishon-Lezion (IL); Albena Samokovlisky, Ashdod (IL); Idil Kasuto Kelson, Tel Aviv (IL); Ana Grosz-Moraga, Jerusalem (IL); Leonid Shvartser, Ashdod (IL)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/493,050

(22) PCT Filed: Oct. 16, 2002
(86) PCT No.: PCT/IB02/04631

(30) Foreign Application Priority Data
Oct. 16, 2001 (US) 60329744

(51) Int. Cl. F16B 21/00

(52) U.S. Cl. 411/344

(57) ABSTRACT

Disclosed are methods of making oligosaccharide libraries whose members have defined structural and/or functional properties, as well as methods of making and using the oligosaccharide libraries.

### FIELD OF THE INVENTION

The invention relates generally to a method for preparation of laminarin oligosaccharides.

### BACKGROUND OF THE INVENTION

Laminarin is a storage polysaccharide of Laminaria digitata and other brown algae. Laminarin oligosaccharides are made of linear β (1-3)-glucose subunits (glucans) and include some β(1-6)-glucan linkages. Laminarin is often provided as laminarin sulphate (LS), a highly sulphated polysaccharide, which exhibits biological activities of clinical relevance.

Polysaccharides such as laminarin are thought to interact with multiple cell types. For example, glucan-containing polysaccharides have been reported to interact with membrane receptors on the macrophage, neutrophil, and natural killer (NK) cells of the immune system. Oligosaccharides are also reported to also modulate the effects of non-immune system cells. Receptors for oligosaccharides are expressed on human fibroblasts, and oligosaccharides can directly modulate the functional activity of normal human dermal fibroblasts. In addition, a polysulphated derivative of sulphate, named Lam S5 inhibits basic fibroblast growth factor (bFGF) binding and the bFGF-stimulated proliferation of fetal bovine heart endothelial cells.

Chemically sulphated laminarin oligosaccharides (LS) are useful as anti-metastatic agents useful in the treatment of cancer. At least one such anti-metastatic activity can occur through the ability of laminarin to inhibit the enzyme heparanase. Heparanase activity correlates with the metastatic potential of tumor cells. The anti-metastatic effect of non-anti-coagulant species of heparan and certain sulphated polysaccharides has been attributed to their heparanase-inhibiting activity. For example, a single injection of LS, before intravenous inoculation of the melanoma or breast carcinoma cells has been reported to inhibit the extent of lung colonization by the tumor cells.

Despite the availability of LS, there is still a need for purified preparations of LS fractions that have defined structures and bioactivities.

### SUMMARY OF THE INVENTION

The invention is based in part of the discovery of methods for identifying purified preparations of oligosaccharides that have known structural and functional properties. In one aspect, the invention provides a method of producing a library of oligosaccharides. The method includes providing a population of oligosaccharides, separating the population of oligosaccharides, thereby forming a plurality of subpopulations of fragments, and identifying a fingerprint for each of said plurality of subpopulations of fragments. Examples of suitable oligosaccharides include, e.g., laminarin, laminarin sulphate, heparin, and heparan sulphate.

In some embodiments, the fingerprint is identified by a method that includes contacting a first subpopulation of oligosaccharides with a first saccharide-binding agent and a second saccharide-binding agent; and determining whether the first saccharide-binding agent and second saccharide binding agent bind said first subpopulation of oligosaccharides.

The method optionally includes contacting a second subpopulation of oligosaccharides with the first saccharide-binding agent and the second saccharide-binding agent, and determining whether the first saccharide-binding agent and second saccharide binding agent bind said second subpopulation of oligosaccharides.

In some embodiments, the fingerprint is determined by contacting the first subpopulation of oligosaccharides with at least two saccharide binding agents (e.g., at least 3, 5, 10, 15, 25, 50, 75, or 100 saccharide binding agents) and determining whether the saccharide binding agents bind to the first subpopulation of oligosaccharides.

A preferred method of determining binding of the first and second saccharide-agent includes providing a surface comprising at least one first saccharide-binding agent attached to a predetermined location on said surface and contacting the surface with the subpopulation of oligosaccharides under conditions allowing for the formation of a first complex between the first saccharide-binding agent and said subpopulation. The surface is then contacted with at least one second saccharide-binding agent under conditions allowing for formation of a second complex between the first complex and the second saccharide-binding agent and the first saccharide-binding agent and second saccharide-binding agent in the second complex is identified. The second saccharide-binding agent preferably includes a detectable label, e.g., a chromogenic label, a radiolabel, a fluorescent label, and a biotinylated label.

The population of oligosaccharides is separated by any desired structural or functional property, e.g., by size. One suitable method for size-based separation is size exclusion chromatography.

Examples of suitable saccharide binding agents include, a lectin, a saccharide-cleaving enzyme, an antibody to a saccharide, FGF, ATIII, bFGF, EGF, FacXa, FGF4, FGF9, Fibronectin, IFN-γ, IGF, IL2, KGF, hmLF, VEGF, Vitronectin, Lami, ApoE4, Heparanase 1, Heparanase 2, Heparanase 3, HGF, IL-12, and TNFα.

In some embodiments, the subpopulation of oligosaccharides is digested with a saccharide-cleaving agent prior to, or subsequent to, separation. Suitable saccharide cleaving agents include, e.g., heparanase and laminarinase.

As used herein, a fingerprint refers to the total information available about the binding status of an oligosaccharide with respect to a saccharide-binding agent In some embodiments, the fingerprint includes information for at least five saccharide-binding agents. For example, the fingerprint may include information for 10, 15, 25, 50, 75, or 100 or more saccharide-binding agents.

Also provided by the invention is an oligosaccharide library that includes a plurality of oligosaccharide subpopulations. Preferably, most or all of the subpopulations have a known fingerprint. The library can be produced from any desired oligosaccharide, e.g., laminarin. In some embodiments, the subpopulations in the library differ from one another in size. In some embodiments, the fingerprint includes information for at least five saccharide-binding agents. For example, the fingerprint may include information for 10, 15, 25, 50, 75, or 100 or more saccharide-binding agents.

Also provided by the invention is a method of producing a purified laminarin or LS fragment by providing a population of laminarin or LS fragments and separating the population of laminarin or LS fragments to form a subpopulation of laminarin or LS fragments. One or more subpopulations comprising fragments including 8 to 30 glucose subunits is identified. Examples include laminarin or LS with sizes less than about 30 glucose units, and/or less than about 25, 20, 18, 16, 14, 12, or 10 units. The subpopulations are then separated to form a plurality of sub-subpopulations of laminarin or LS fragments, and one or more sub-subpopulations including about 8 to about 30 glucose units is identified. Preferably, the sized fractions in include laminarin or LS that are at least about 16 glucose units in length.

By “substantially purified” is meant a laminarin or LS molecule or biologically active portion thereof is substantially free of cellular material or other contaminating macromolecules, e.g., polysaccharides, nucleic acids, or proteins, from the cell or tissue source from which the laminarin or LS fraction is derived, or substantially free from chemical precursors or other chemicals when chemically synthesized. The language “substantially free of cellular material” includes preparations of laminarin or LS that is separated from cellular components of the cells from which it is isolated or recombinantly produced. In one embodiment, the language “substantially free of cellular material” includes preparations of laminarin or LS having less than about 30% (by dry weight) of non-laminarin-like compounds, e.g., non-laminarin polysaccharides, more preferably less than about 20%, 10%, 5%, 1%, 0.5%, or 0.1%.

In some embodiments, a SEC-P10 column is used to separate the starting population and/or the subpopulation.

The laminarin or LS fragments described herein can be provided substantially free of chemical precursors or other chemicals. The language “substantially free of chemical precursors or other chemicals” includes preparations of LS in which the LS fraction is separated from chemical precursors or other chemicals that are involved in its synthesis. In one embodiment, the language “substantially free of chemical precursors or other chemicals” includes preparations of LS having less than about 30% (by dry weight) of chemical precursors or non-LS chemicals, more preferably less than about 20% chemical precursors or non-LS chemicals, still more preferably less than about 10% chemical precursors or non-non-LS chemicals, and most preferably less than about 5%, 1%, 0.5%, 0.3%, or even less than about 0.2% chemical precursors or non-LS chemicals.

Any population of starting laminarin molecules can be used as the starting population. In some embodiments, the population includes a plurality of partially hydrolyzed laminarin molecules. Hydrolysis is preferably performed by digesting the population with laminarinase. Alternatively, or in addition, the method further can further include altering the sulphation state of the population of laminarin fragments prior to separating the population. Such alterations may increase or decrease the sulphation state of the laminarin fragments. Also within the invention is a purified LS produced by the method.

Unless otherwise defined, all technical and scientific terms used herein have the same meaning as commonly understood by one of ordinary skin in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions, will control. In addition, the materials, methods, and examples are illustrative only and not intended to be limiting.

Other features and advantages of the invention will be apparent from the following detailed description and claims.

### BRIEF DESCRIPTION OF THE DRAWINGS

FIG. 1 is a graphical representation of the spectral properties of LS.

FIG. 2 is a graphical representation showing the linear relationship between absorbance at 210 nm and LS concentration.

FIG. 3 is a graphical representation showing the linear relationship between absorbance at 620 nm and LS concentration as determined by the Taylor's blue assay.

FIG. 4 is a representation of the dimensions, composition, and flow characteristics of the Bio-Gel P-10 gel filtration columns used to fractionate laminarin and LS.

FIG. 5 is a representation of the heparin calibration standards and dyes employed to characterize the 250 ml Bio-Gel P-10 gel filtration column used to fractionate laminarin and LS.

FIG. 6 is a representation of the heparin calibration standards and dyes used to characterize the 414 ml Bio-Gel P-10 gel filtration column employed to fractionate laminarin and LS.

FIG. 7 is a graphical representation of the elution profile of heparin calibration standards used to characterize the 250 ml Bio-Gel P-10 gel filtration column employed to fractionate laminarin and LS.

FIG. 8 is a graphical representation of the elution profile of heparin calibration standards used to characterize the 414 ml Bio-Gel P-10 gel filtration column employed to fractionate laminarin and LS.

FIG. 9 is a representation of the calculated and observed elution volumes for the heparin calibration standards and dyes used to characterize the Bio-Gel P-10 gel filtration columns employed to fractionate LS.

FIG. 10 is a representation of the LS-containing sample mixture fractionated on a 250 ml Bio-Gel P-10 gel filtration column.

FIG. 11 is a graphical representation showing the elution profiles obtained from two separations of LS using a 250 ml Bio-Gel P-10 gel filtration column.

FIG. 12 is a representation of a PAGE analysis of fractions 1-40 of LS separated on a 250 ml Bio-Gel P-10 gel filtration column. Molecular weight markers (heparin std., IDURON) are 26 DP, 2ODP, 16 DP, 12 DP, 8 DP and 2 DP, respectively.

FIG. 13 is a representation of the LS-containing sample mixture fractionated on a 414 ml Bio-Gel P-10 gel filtration column. The LS material was obtained by pooling fractions from two gel filtration separations of LS on a 250 ml Bio-Gel P-10 gel filtration column. Fractions 24 to 27 from separation #1 were pooled with fractions 24+26 from separation #2.

FIG. 14 is a graphical representation of the elution profile of LS fractionated using a 414 ml Bio-Gel P-10 gel filtration column. The LS material was obtained by pooling fractions from two gel filtration separations of LS on a 250 ml Bio-Gel P-10 gel filtration column. Fractions 24 to 27 from separation #1 were pooled with fractions 24+26 from separation #2.

FIG. 15 is a graphical representation of the results of laminarinase digestion of laminarin at a laminarin-to-laminarinase ratio of 1 mg:7 mU. Laminarin, laminarinase and buffer Na acetate (pH5) were mixed at final concentrations of 10 mg/ml, 70 mU/ml, and 50 mM, respectively. Distilled water was added to the final volume of 1 ml. Reagents were mixed and incubated in a heating block preheated to 37° C. Samples of 110 μl were taken at 0, 10, 20, 30, 40, 60, 120, and 180 min. Samples were boiled for 2-5 min to stop the reaction. After appropriate dilution BCA reducing end test was performed. Results are the mean of duplicate determinations.

FIG. 16 is a graphical representation of laminarinase digestion of laminarin at a laminarin-to-laminarinase ratio of 1 mg:0.7mU. Laminarin, laminarinase and buffer Na acetate (pH5) were mixed at final concentrations of 10 mg/ml, 7 mU/ml, and 50 mM, respectively. Distilled water was added to the final volume of 1 ml. Reagents were mixed and incubated in a heating block preheated to 37° C. Samples of 110 μl were taken at 0, 10, 20, 30, 40, 60, 80, and 120 min. Samples were boiled for 2-5 min to stop the reaction. After appropriate dilution BCA reducing end test was performed. Results are the mean of duplicate determinations.

FIG. 17 is a representation of the total sulphate content obtained after sulphation of size-reduced laminarin preparations using 8 molar equivalents of SO₃Pyr.

FIG. 18 is a representation of PAGE analysis of size-reduced laminarin preparations sulphated using 8 molar equivalents of SO₃Pyr.

FIG. 19 is a representation of the total sulphate content obtained after sulphation of size-reduced laminarin preparations using 8 molar equivalents of SO₃Pyr.

FIG. 20 is a representation of the PAGE analysis of size-reduced laminarin preparations sulphated using 8 molar equivalents of SO₃Pyr.

FIG. 21 is a PAGE gel of LS library fractions.

FIG. 22 is a graph showing the molecular size of individual LS library fractions.

FIG. 23 is a graph showing the binding fingerprint of LS 1.

FIG. 24 is a graph showing the binding fingerprint of LS2.

FIG. 25 is a graph showing the binding fingerprint of LS3.

FIG. 26 is a graph showing the binding fingerprint of LS4.

FIG. 27 is a graph showing the binding fingerprint of LS5.

FIG. 28 is a graph showing the binding fingerprint of LS6.

FIG. 29 is a graph showing the binding fingerprint of LS7.

FIG. 30 is a graph showing the binding fingerprint of LS8.

FIG. 31 is a graph showing the binding fingerprint of LS9.

FIG. 32 is a graph showing the binding fingerprint of LS10.

FIG. 33 is a graph showing the binding fingerprint of LS 11.

FIG. 34 is a graph showing the binding fingerprint of LS12.

FIG. 35 is a graph showing the binding fingerprint of LS13.

FIG. 36 is a graph showing the binding fingerprint of LS 14.

FIG. 37 is a graph showing the binding fingerprint of LS 15.

### DETAILED DESCRIPTION OF THE INVENTION

The invention provides methods of producing oligosaccharides, including sulphated oligosaccharides, separating the oligosaccharides into subpopulations, and then identifying properties associated with members of the subpopulations. The subpopoulations can be provided as libraries whose members with defined functional properties. These properties include, e.g., ability to bind oligosaccharide proteins with demonstrated biological activities (such as angiogenesis, tumor inhibition and inflammation). The activity of at least some oligosaccharide-binding proteins is dependent on binding to oligosaccharides. Thus, the oligosaccharides produced herein, and libraries containing these oligosaccharide are useful as anti-angiogenic, anti-metastatic and/or anti-inflammatory agents.

The invention is illustrated by providing methods of producing a substantially purified laminarin or LS fragments, although the methods of the invention are readily adapted to other oligosaccharides.

A starting population of laminarin or LS fragments is conveniently separated to from a subpopulation of laminarin or LS fragments. One or more subpopulations comprising fragments including 8 to 30 glucose subunits is typically identified. Examples include laminarin or LS with sizes less than about 30 glucose units, and/or less than about 25, 20, 18, 16, 14, 12, or 10 units. The subpopulations are then separated to form a plurality of sub-subpopulations of laminarin or LS fragments, and one or more sub-subpopulations including about 8 to about 30 glucose units is identified. In other embodiments, the sized fractions include laminarin or LS that are at least about 16 glucose units in length.

In some embodiments, size exclusion chromatography column (SEC) column with a 10 kDa exclusion limit is used to separate the starting population and/or the subpopulation of laminarin or LS fragment. A suitable column is a BioGel P-10 column, however, any gel chromatography purification matrix yielding a 10 kDa size exclusion can be used to purify the laminarin or LS fragment. Furthermore, the conditions for separation, e.g., flow rate, time, gel filtration column length and number, buffer composition, and temperature may be adjusted by one skilled in the art of purification to yield the substantially purified laminarin or LS fragment of the present invention.

Any population of starting laminarin molecules can be used as the starting population. In some embodiments, the population includes a plurality of partially hydrolyzed laminarin molecules. Controlled hydrolysis can be obtained chemically or enzymatically. Controlled hydrolysis is preferably performed by digesting the population with laminarinase. In this regard, the source of laminarinase is not critical to the preparation of the starting population of laminarin molecules. A suitable enzyme source is laminarinase from Penicillium sp. Furthermore, the conditions for hydrolysis, e.g., enzyme quantity, reaction temperature, time and buffer composition, may be adjusted by one skilled in the art to yield the substantially purified laminarin or LS fragment of the present invention.

Alternatively, or in addition, the method further may optionally include altering the sulphation state of the population of laminarin fragments prior to separating the population. Such alterations may increase or decrease the sulphation state of the laminarin fragments. Also within the invention is a purified LS produced by the method.

The oligosaccharides of this invention may optionally be prepared by sulphation of the oligosaccharides by methods known in the art to give their corresponding O-sulphated derivatives. Suitable sulphation methods are discussed below. The oligosaccharides to be sulphated may optionally be naturally occurring products, as well as oligosaccharides prepared by enzymatic or chemical degradation of naturally occurring polysaccharides. Moreover, the oligosaccharides may optionally and alternatively be prepared by chemical synthesis. Optionally and more preferably, the sugar units are glucose units, although other types of sugar units may alternatively be present in addition to, or in place of, the glucose units.

Some oligosaccharides can be obtained from natural sources for subsequent sulphation. alternatively, procedures for synthesizing oligosaccharides of defined chain length and stereochemistry can be used. Such procedures are described in, e.g., Alban et al., Forsch. Drug Res. 42 (II):1105-08, 1992, U.S. Pat. No. 6,143,730. Hoffman et al., Br. J. Cancer 73:1183-86, 1996, methods described herein (see Examples). One method suitable for sulfation of laminarin fragment, for example, is chemical reaction of laminarin fragment with pyridine-sulphur-trioxide complex (Pyr.SO₃) to yield LS.

In the Examples described herein, the sulphated oligosaccharides are isolated and used as their respective sodium salts. Other pharmaceutically acceptable salts, including but not limited to calcium or pharmaceutically acceptable amine salts, may be isolated and used in the corresponding manner. Accordingly, references herein to a “sulphated oligosaccharide” are to be understood as including such sodium or other pharmaceutically acceptable salts of the sulphated oligosaccharides.

Laminarin and LS fragments can be screened for their ability to bind proteins (including heparin-binding proteins) using methods known in the art. Preferred methods include the GMD/SAR methods disclosed in WO 00/68688, WO 01/84147, WO 02/37106, and WO 02/44714. As shown in Example 4, this technique can be used to generate fingerprints which identify the laminarin fragments of the present invention and define unique structure-activity relationships present (GMID™SAR™).

The methods of the present invention are not limited to the preparation and screening of laminarins or laminarin sulphates alone. This invention provides for the use and screening of such biologically active glycomolecules as, e.g., proteoglycans rich in sulphated glycosaminoglycan chains, chondroitin, heparin, heparan and dermatan sulphates. The present invention also provides for the use and screening of glycomolecules that carry either a positive, negative, or neutral charge. Furthermore, the glycomolecules may be derived from any source expressing glycomolecules, e.g., mammals, parasites, fungi, bacteria, mycobacteria, plants, insects, virus, and the like.

The invention will be further illustrated in the following non-limiting examples.

### EXAMPLE 1

### Isolating LS Fragments

Detection and Quantification of LS

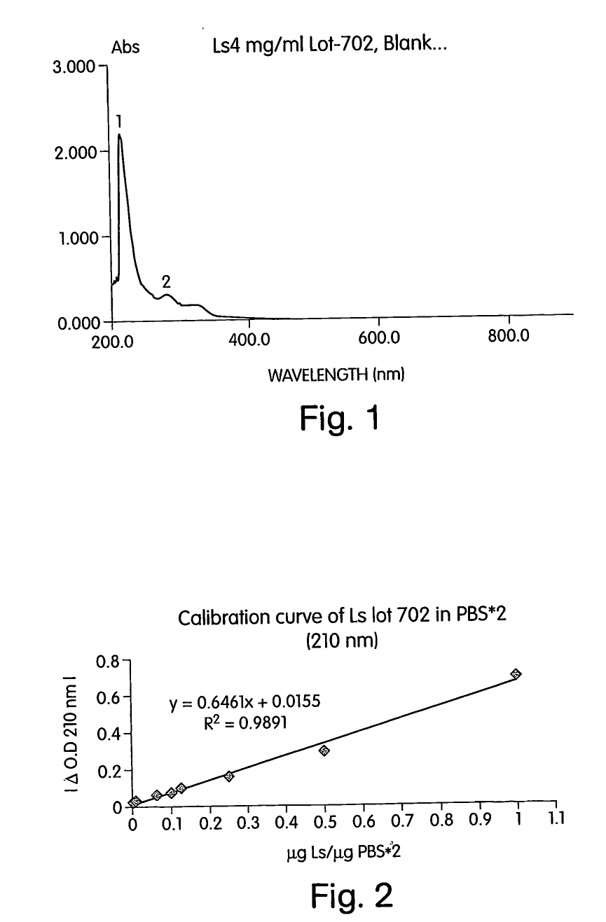

Laminarin sulphate was detected spectrophotometrically at 210 nm (FIG. 1). As shown in FIG. 1, LS has three absorbance peaks at 206, 273, and 325 nm. The maximal absorbance at 210 nm was selected as a means to detect the presence of LS in test samples. Reference curves such as that shown in FIG. 2, reveal a direct relationship between the absorbance at 210 nm and LS concentration up to 1 mg LS/ml sample.

Alternatively, sulphated oligosaccharide content was determined using Taylor's blue assay essentially as described by Farndale et al., Connective Tissue Research 9: 247-248 (1982). Briefly, Taylor's blue dye reagent was prepared by dissolving 16 mg of 1,9-dimethyl methylene blue (DMB; Merk, Darmstadt, DE) in 5 ml ethanol. To this solution, 2 g of sodium formate and 2 ml of formic acid were added. This mixture was diluted to approximately 1 L with distilled water and the resulting solution was stored light protected at room temperature in an amber bottle.

To determine the total sulphated carbohydrate content, test sample or control (0 to 0.065 μg LS/μl) 16 μl of LS in conc. between 0-0.065 μg LS/μl was pipetted into the appropriate well of a 96-well polystyrene ELISA plate. A control well containing 16 μl distilled water alone served as a sample blank. One hundred microliters of DMB dye reagent was added to each well and mixed using a pipet station. Samples were incubated up to 30 min at room temperature prior to spectrophotometric determination of the sulphated carbohydrate content at 620 nm. Sulphated carbohydrate causes a color change in the DMB dye reagent from purple to pink.

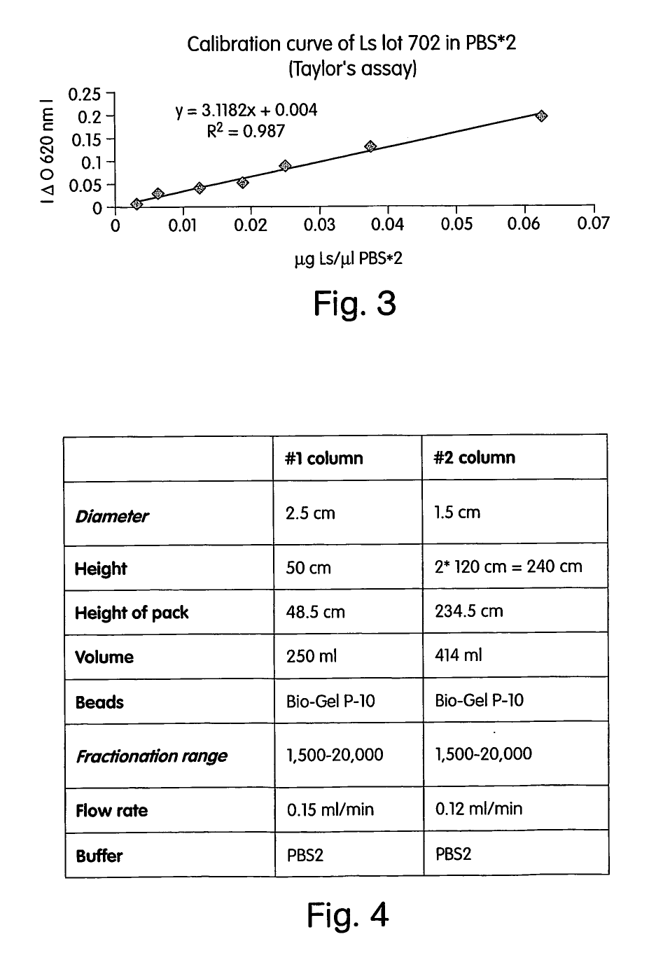

Sulphated carbohydrate content of test sample(s) can be extrapolated from a standard response curve constructed using the control LS (FIG. 3). As shown in FIG. 3, a calibration curve of LS in phosphate buffered saline quantified by Taylor's blue assay showed a direct linear relationship between absorbance at 620 nm and LS concentration up to 0.0625 μg LS/μl.

Calibration of Bio-Gel P-10 Gel Filtration Columns

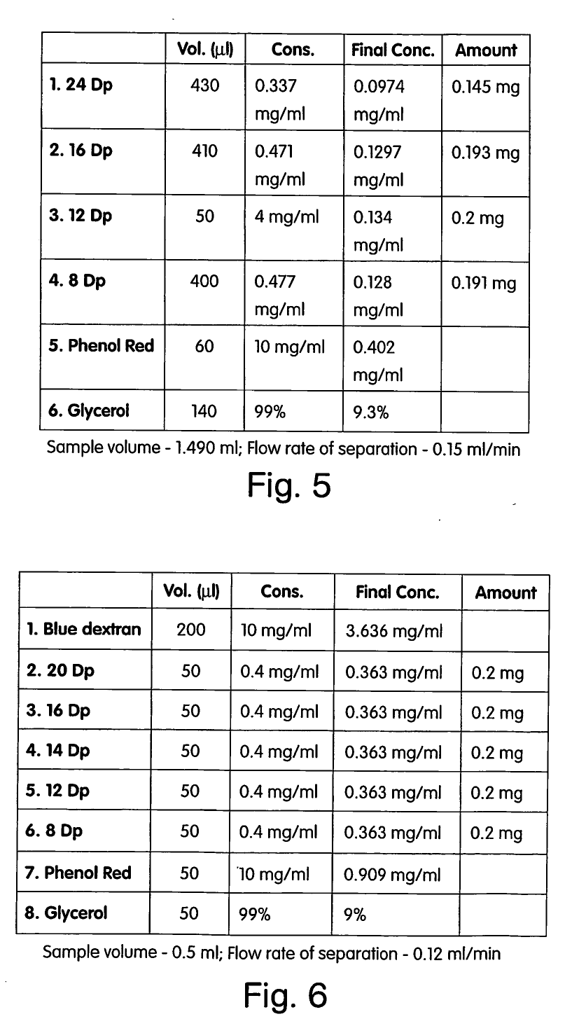

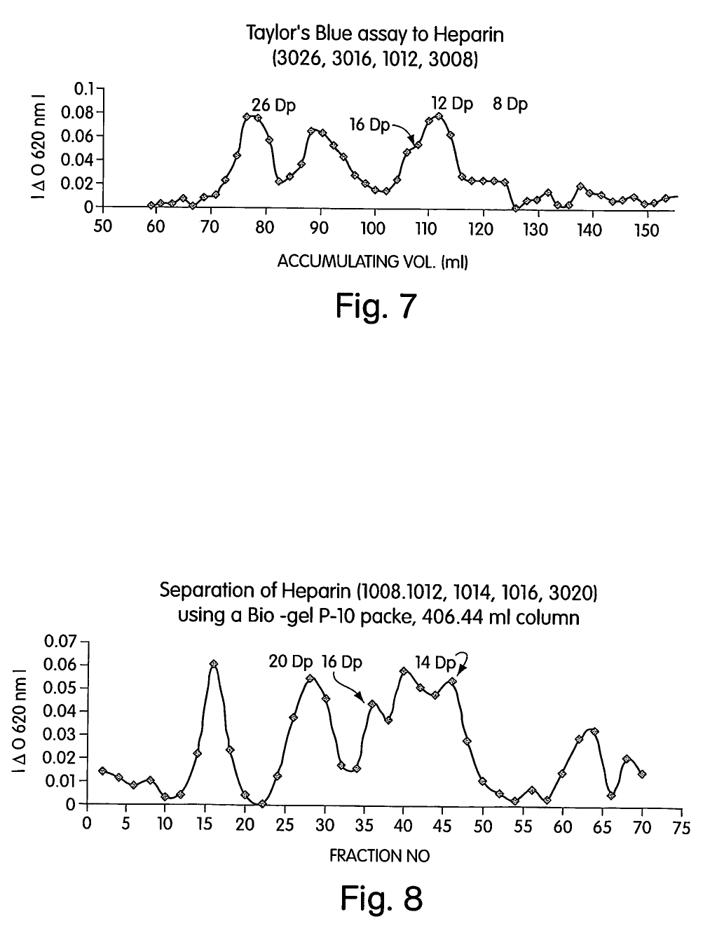

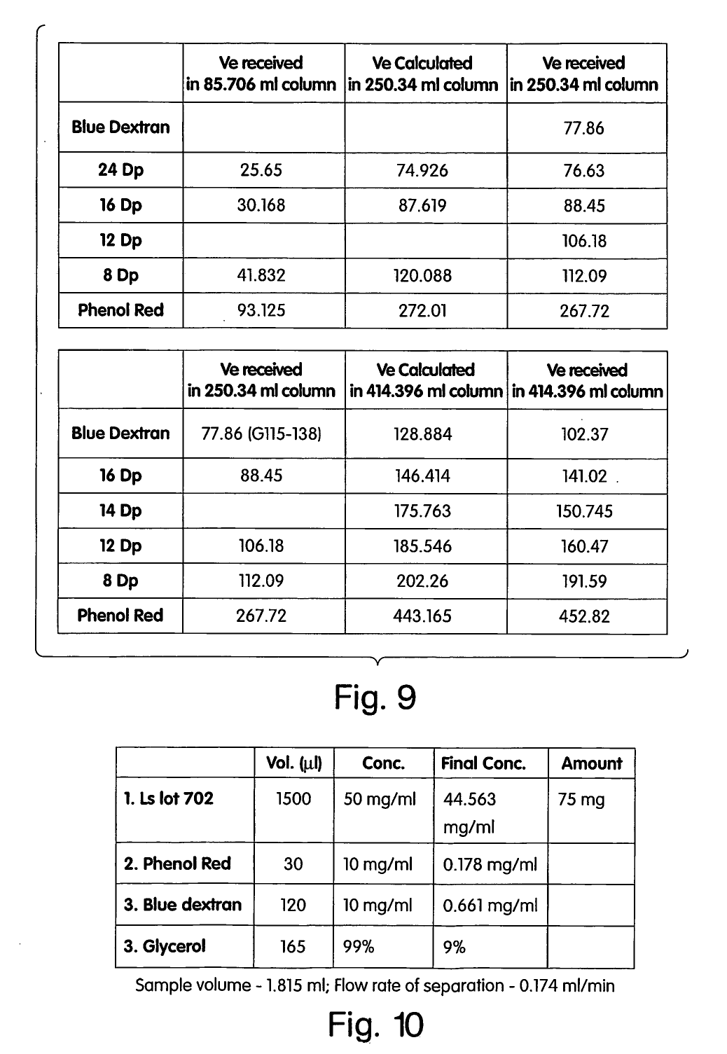

Two different Bio-Gel P-10 gel filtration columns (SEC-P10) were used to purify and characterize laminarin or LS-containing fractions. The dimensions and flow rates of these 250 ml and 414 ml Bio-Gel P-10 gel filtration columns are summarized in FIG. 4. The separation characteristics of these Bio-Gel P-10 gel filtration columns were determined using both heparin calibration standards of defined oligosaccharide length [2, 8, 12, 16, 20, 26 degree of polarization (Dp); Iduron, Manchester, UK] and dyes (FIGS. 5 and 6). Specifically, blue dextran was used to determine the void volume of the gel filtration columns. Phenol red was used to determine the total volume of the gel filtration columns. The separation of the heparin calibration standards on the 250 ml and 414 ml Bio-Gel P-10 gel filtration columns are shown in FIG. 7 and FIG. 8, respectively. Comparisons of the calculated elution volumes (Ve) of the heparin calibration standards and dyes for these columns were in good agreement with the observed Ve for the heparin calibration standards and dyes (FIG. 9). Generally, the observed Ve values were within 10% of the expected, calculated Ve values. This agreement is consistent with the high precision with which the size of oligosaccharides, including LS, may be reproducibly determined using these methods.

Fractionation of LS by Gel Filtration Chromatography

Oligosaccharides of LS were isolated by gel filtration (size exclusion) chromatography. The sample contains LS, blue dextran, phenol red, and glycerol as summarized in FIG. 10. Sample [up to 1% (v/v) of the total volume of the column] was applied to the top of a Bio-Gel P-10 polyacrylamide gel filtration column (jacketed) which had been stabilized over the course of two days by equilibrating the column with 2× PBS (flow rate 0.174 ml per min) at 25° C. Eluate from the column was collected in 1-2 ml fractions.

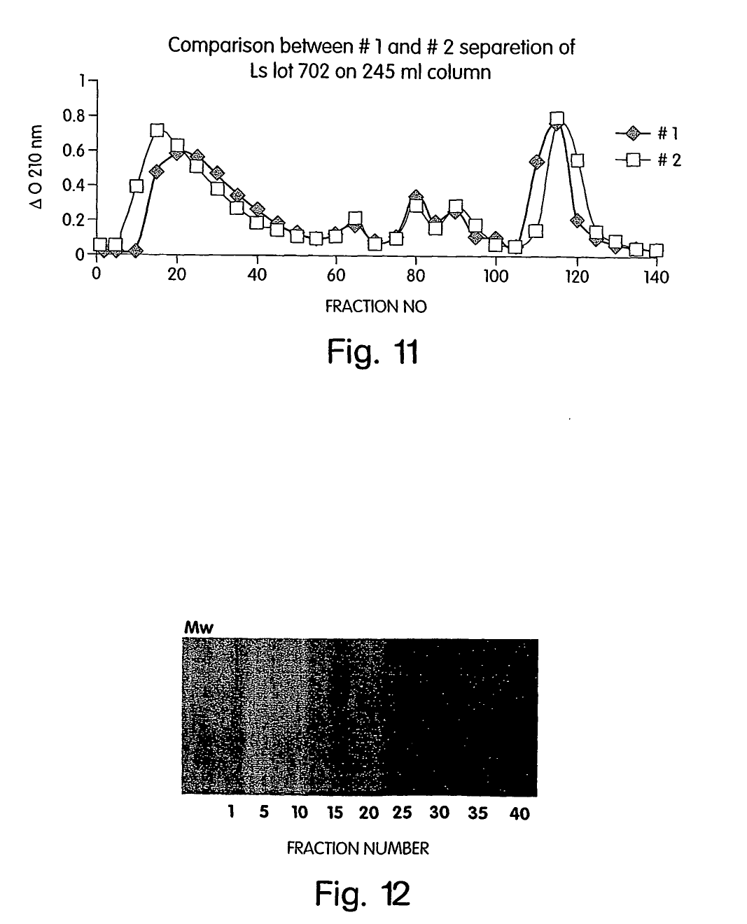

The LS oligosaccharides were well resolved by the 250 ml Bio-Gel P-10 gel filtration column (FIG. 11). The elution profiles observed between multiple separations of LS are reproducible. It is noteworthy that the last peak appearing on the elution profile is due to the presence of phenol red dye. Characterization of the LS fractions by PAGE analysis (FIG. 12) supported the observations made using the Taylor's blue sulphated oligosaccharide assay (Cf. FIG. 11). Both the Taylor's blue assay and PAGE indicated that LS fractions 25-60 (102.7-172.7 ml) contains LS.

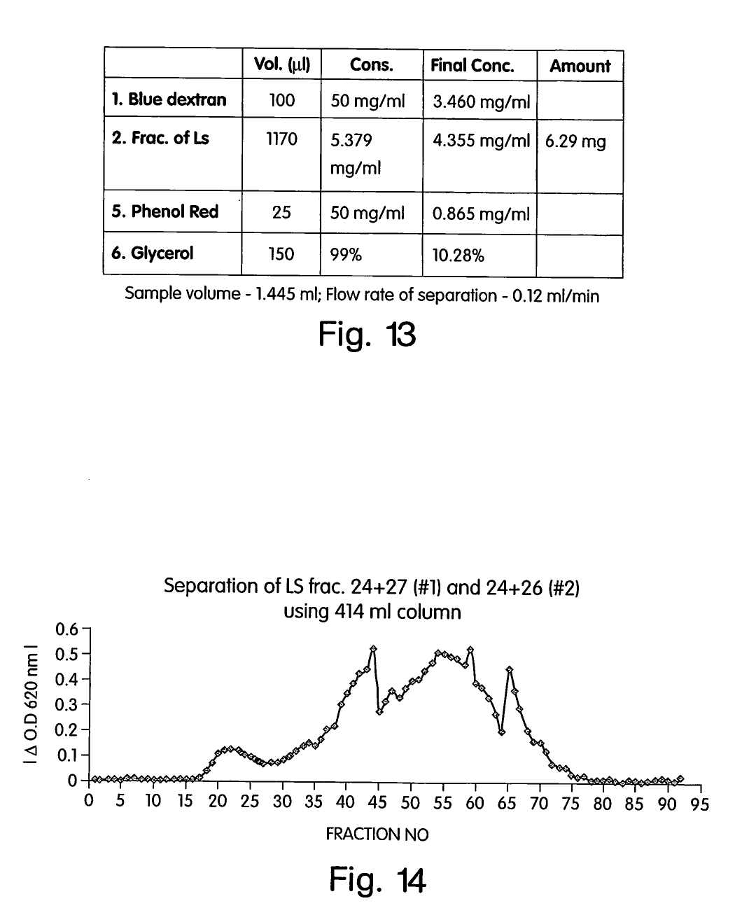

FIG. 13 summarizes an LS-containing sample mixture fractionated on a 414 ml Bio-Gel P-10 gel filtration column. The LS material was obtained by pooling fractions from two gel filtration separations of LS on a 250 ml Bio-Gel P-10 gel filtration column. Fractions 24+27 from separation #1 (Cf. FIG. 11) were pooled with fractions 24+26 from separation #2 (Cf. FIG. 11). As shown in FIG. 14, pooled LS oligosaccharide eluted from the 414 ml Bio-Gel P-10 gel filtration column in fractions 29−75 (108.1-158.24 ml).

### EXAMPLE 2

### Modification of Laminarin Fragments

This example describes digestion of laminarin under defined conditions to yield laminarin fragments of defined length. These fragments were subsequently sulphated by chemical reaction with pyridine-sulfur-trioxide complex (Pyr.SO₃) to yield LS. This method yields an oligosaccharide library comprised of diverse LS derivatives.

Controlled Digestion of Laminarin with Laminarinase

Laminarin is a storage polysaccharide of Laminaria and other brown algae; made up of β (1-3)-glucan with some β (1-6)-glucan linkages. Laminarinase (1,3-[1,3 4]-beta-D-Glucan 3[4]-glucanohydrolase; Penicillium sp.; enzyme commission number 3.2.1.6) is an endoglycosidase that hydrolytically cleaves the β(1,3)-glucan linkages found in laminarin. In these studies, laminarin (Laminaria digitata; mol. wt.=5,000 g/mol; Sigma Chemical Co., St. Louis, Mo., USA) was enzymatically digested to fragments of reduced length with laminarinase (Sigma Chemical Co., St. Louis, Mo., USA).

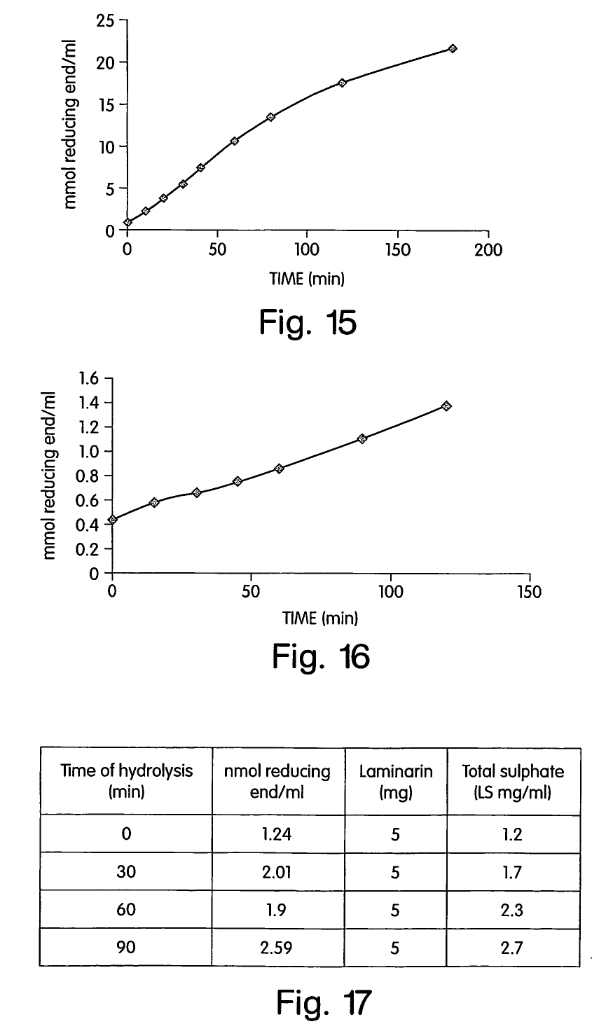

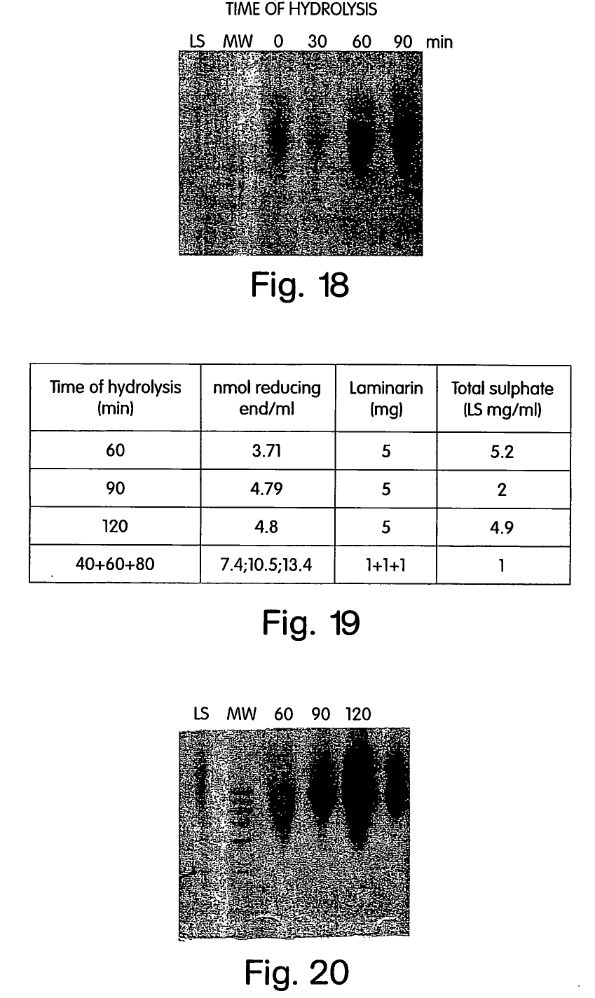

The enzymatic cleavage of laminarin by laminarinase yields an increased number of reducing sugars. As shown in FIG. 15, the rate of hydrolysis of laminarin by laminarinase was monitored by measuring these reducing sugars using disodium-2,2′ bicinchoninate (BCA). Consistent with the known mechanism of action of this endoglycosidase, incubation (37° C.) of laminarin (10 mg/ml) with laminarinase (70 mU/ml) in 50 mM sodium acetate buffer (pH 5) resulted in a time-dependent increase in reducing sugar content. Further, the nearly complete digestion of laminarin by 200 min incubation time is in accord with the expected rate of digestion of this enzyme under conditions where the laminarin-to-laminarinase ratio is 1 mg:7 mU. That is, a single laminarinase enzyme unit liberates 1 mg of reducing sugar (glucose) from laminarin per min at pH 5 at 37° C.

Laminarinase rapidly digested the laminarin substrate as evinced by a 6-fold increase in reducing end content of the test sample at 30 min incubation. Under these reaction conditions a linear increase in reducing end content was observed up to 80 min incubation time. At 30 min incubation time, the laminarin saccharide chains are estimated to be 5 DP in length, assuming that the saccharide fragments of the undigested laminarin substrate material are 30 DP long (deduced from the original molecular weight of laminarin; 5000 g/mol). Although effective, the 1 mg:7 mU laminarin-to-laminarinase ratio was not optimal.

In order to achieve a more controlled digestion of the laminarin substrate, the laminarin-to-laminarinase ratio was reduced to 1 mg:0.7 mU (FIG. 16). As shown in FIG. 16, the 10-fold reduction in laminarinase enzyme concentration resulted in a linear increase in reducing end content of the test sample over 2 h incubation time. These conditions allowed for the controlled enzymatic hydrolysis of laminarin to fragments with different lengths.

Sulphation of Enzymatically Size-Reduced Laminarin Fragments

Laminarin was enzymatically digested to fragments of reduced length with laminarinase, then sulphated by chemical reaction of reducing sugar ends with the sulphate donor, sulfur trioxide pyridine complex (Pyr.SO₃; Merck, Darmstadt, DE). Briefly, laminarin fragments of varying size were generated by incubating laminarin with laminarinase as detailed above. The resulting preparations were sulphated by incubation (4 h, 80° C.) with an 8-fold molar excess of Pyr.SO₃ in N,N-dimethylformamide (DMF; Merck, Darmstadt, DE).

For example, 118 mg of Pyr.SO₃ (8 molar equivalents) was dissolved in 400 μl DMF and the resultant solution added to 5 mg lyophilized laminarin fragments. The lyophilized laminarin fragments were dissolved by triturating the mixture. The reaction mix was incubated at 80° C. for 4 h. After incubation, the reaction mixtures were cooled in the freezer (−20° C.) for approximately 5 min. Fifty microliters of distilled water was added to each reaction mixture. The reaction mixtures were then neutralized [neutral pH was tested with Universal pH indicator (pH 0-14); Merck, Darmstadt, DE). The precipitated LS fragments were then isolated by centrifugation and then decanting other reaction components from the sulphated oligosaccharide. The sulphation of the laminarin fragments was confirmed by the determination of total sulphate content (FIG. 17).

As shown in FIG. 17, increased digestion (up to 90 min) of laminarin with laminarinase results in increased reduced sugar end content. As shown in FIG. 17, there appeared to be efficient donation of sulphate to the reduced sugar ends of laminarin fragments under the conditions of chemical sulphation. Further characterization of LS fragments by PAGE confirmed that the material is sulphated as unsulphated material would not be resolved and stained under these experimental conditions.

Similar results were obtained if laminarin fragments were sulphated as described above, however, rather than isolating the laminarin fragments by precipitation and centrifugation, the LS fragments were isolated by gel filtration chromatography (Cf. FIGS. 19 and 20). Specifically, at the end of the incubation period, the sulphation reaction mix was applied to a Econo-Pac 10DG desalting column (Bio-Rad, Hercules, Calif., USA) and the sample eluted in distilled water. Fourteen column fractions of 500 μl each were collected and then lyophilized. The lyophilized material from fractions 1 to 9 were pooled and the total sulphate content measured.

### EXAMPLE 3

### Profiling of Purified LS Preparations

A protein binding profile of various LS fractions was generated by determining the binding affinity of various fractions to a panel of proteins known to bind oligosaccharide molecules.

To derive the LS fractions, a crude commercial preparation of LS was fractionated by gel filtration chromatography essentially as detailed in Example 1. Briefly, LS, blue dextran, phenol red, and glycerol (up to 1% (v/v) of the total volume of the column) was applied to a Bio-Gel P-10 polyacrylamide gel filtration column jacketed) which had been stabilized over the course of two days by equilibrating the column with 2× PBS (flow rate 0.174 ml per min) at 25° C. Eluate from the column was collected in 1-2 ml fractions and designated LS1 through LS15.

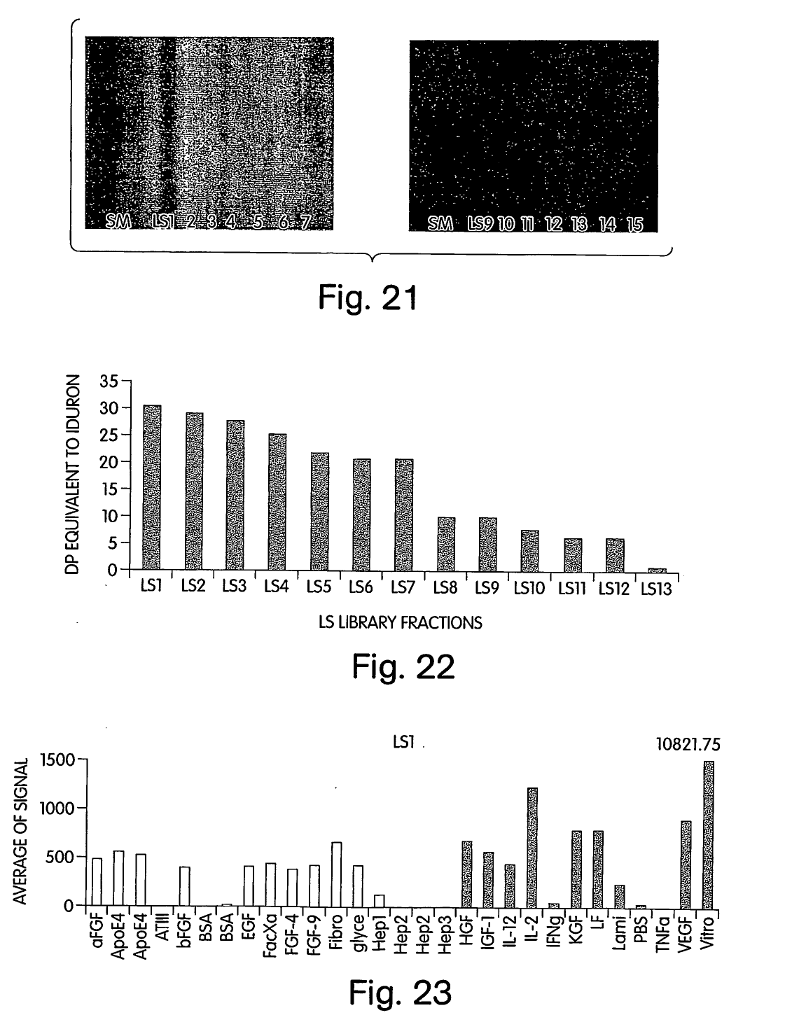

PAGE analysis revealed that the oligosaccharide fractions were well-resolved using 250 ml Bio-Gel P-10 gel filtration column. The LS fractions were numbered LS 1 through LS 15 (FIG. 21). The different fractions were distinguishable as judged by differences observed in their migration in the gel. These results were consistent with results obtained using the Taylor's blue sulphated oligosaccharide assay with absorbance at 210 nm FIG. 22 summarizes the minimum DP of the library fractions calculated using calibration curve derived from heparin fragments of defined size (Iduron, Manchester, UK).

A. General Procedures

Preparation of Protein Panels.

Proteins were printed on FAST-slides using automated 16 pin (diameter 0.4mm) Arrayers. Proteins were printed in 6 replicates, and the arrayer pins were washed between visits. Table 1 shows the proteins assembled in the test panel and the concentration used. Glycerol was added where indicated to stabilize the protein.

TABLE 1

| | | Prot | | |
|---|---|---|---|---|
| | | conc. | | |
| | Protein | mg/ml | Glycerol | Protein |
| 1 | aFGF | 0.5 | + | Acid Fibroblast Growth |
| | | | | Factor |
| 2 | ATIII | 1 | − | Anticoagulation Factor III |
| 3 | bFGF | 0.25 | − | Basic Fibroblast Growth |
| | | | | Factor |
| 4 | EGF | 0.25 | + | Epidermal Growth Factor |
| 5 | FacXa | 1 | − | Factor Xa |
| 6 | FGF4 | 2 | − | Fibroblast Growth Factor 4 |
| 7 | FGF9 | 2 | − | Fibroblast Growth Factor 9 |
| 8 | Fibronectin | 0.25 | + | |
| 9 | IFN-gamma | 0.5 | − | Interferon gamma |
| 10 | IGF | 0.5 | + | Insulin Growth Factor |
| 11 | IL2 | 1 | + | Interleucking 2 |
| 12 | KGF | 0.5 | + | Keratinocyte Growth Factor |
| 13 | hmLF | 0.5 | + | Human Milk Lactoferrin |
| 14 | VEGF | 0.5 | + | Vascular Endotelial Growth |
| | | | | Factor |
| 15 | Vitronectin | 0.6 | − | |
| 16 | Lami | 0.25 | − | Laminin |
| 17 | ApoE4 | 0.45 | − | Apolipoprotein E4 |
| | | 0.225 | + | |
| 18 | Heparanase 1 | 1.76 | − | |
| 19 | Heparanase 2 | 3.6 | − | |
| | | 1.8 | − | |
| 20 | Heparanase 3 | 2 | − | |
| 21 | HGF | 0.5 | + | Heppatocyte Growth Factor |
| 22 | IL-12 | 0.1 | + | Interleucking 12 |
| 23 | TNFa | 1 | − | Tumor Necrosis Factor |

The proteins used included fibroblast growth factor (FGF); antithrombin III (ATIII); epidermal growth factor (EGF); interferon (IFN); insulin-like growth factor (IFN); keratinocyte growth factor (KGF); vascular endothelial growth factor (VEGF); Apolipoprotein E4 (ApoE4); hepatocyte growth factor (HGF); and tumor necrosis factor The printed proteins were allowed to bind to the slide at room temperature for 1 h. Slides were then transferred to slide racks and washed in 1 L PBS for 1 min with constant stiring. Slides rack were incubated in 300 ml of 0.5% BSA (block solution) at 4° C. over night and then washed 3 times with 1 L of PBS for 5 min with constant stiring. Slides were transferred to petri dishes and incubated with 0.25 ml of 100 nmol labeled probe/ml PBS for 0.5 h with gentle shaking (25 rpm/min) at room temperature. Following incubation with labeled probe, the slides were washed by dipping of the slide racks 10 times into a beaker with 1 L PBS. Slides were then equilibrated with distilled H₂O by dipping the slide-rack 4 times in beaker with 1 L of distilled H₂O. Slides were centrifuged at 200 g, 25° C. for 3min and then stored in a slide-box at 4° C. until scanning. Slides were scanned with an LIF-scanner at 488 nm-FITC, with laser power of 65, PMT of 60 and Focus at −2000. Results were analyzed with an Array-Pro32.

Lyophilized polysaccharide (100 nmole) was fluorescently labeled by reductive amination reaction as follows. Polysaccharide (100 nmole) was incubated at 37° C. overnight (˜16 h) with 60 μl of freshly prepared 0.06 M 2-Amino-6-cyanoethylpyridine (AMAC; Molecular Probes, Eugene, Oreg.., USA; 16.37 mg/ml) in formamide. Following incubation, 6 μl of freshly prepared 1 M NaBH₄ (Aldrich Chemical Company, Milwaukee, Wis., USA; 38 mg/ml in DMSO) was added to the labeling reaction and the resulting mixture was vortexed for 1 h at 25° C. The labeled polysaccharide was separated from unbound AMAC using a desalting column (Econo-Pac DG10, Bio-Rad, Richmond,Va., USA). The concentration of labeled polysaccharide was spectrophotometrically determined at 400 nm (AMAC), 210 nm (LS), or 232 nm (heparin). Labeled polysaccharide was lyophilized, resuspended in 20 μl of water and then brought to 100 nmol/ml working concentration with the addition of an appropriate volume of 1×PBS.

Binding of each LS fraction to the various oligosaccharide binding proteins was determined and compiled. The binding data was then analyzed by the Lingvo software program (Intelligent Data Mining, Inc. East Brunswick, N.J., USA; see also Braverman, E. M, and I. B. Muchnik, Structure Methods for Empiric Data Processing, Nauka, Moscow, 1983; and Braverman, E. M., “Methods of extreme grouping of parameters, and the problem of essential factors extracting”, Avtomatica i telemehanica, No.1, 1970, pp. 123-132 (in Russian, translated into English for Automation and Remote Control, same volume and publication information), which is a cluster analysis program. In the analysis below, each LS fraction is an object whose characteristics are to be analyzed, while each protein is expressed as a parameter for characterizing the LS object. A summary of the mean binding for each protein is presented in Table 2, along with the deviation (absolute) and deviation (percent). Proteins or proteins showing similar binding profiles, in terms of the LS fractions to which they bound, were placed into groups. For the proteins analyzed, five factors, and hence five groups of proteins having similar binding characteristics, were identified. Each factor provides a measure of the overall binding profile for the proteins in the respective group. The number of proteins (or parameters) in each factor group is presented in Table 3.

TABLE 2

| Name | Mean | Deviation(abs) | Deviation(%) | Factor |
|---|---|---|---|---|
| aFGF | 575.5778 | 100.9651 | 17.5415 | 1 |
| ApoE4 | 1248.9611 | 517.9821 | 41.4730 | 3 |
| ApoE4 | 1364.6111 | 552.1224 | 40.4601 | 3 |
| ATIII | 102.5111 | 150.4594 | 146.7738 | 4 |
| bFGF | 520.8444 | 332.2868 | 63.7977 | 4 |
| EGF | 333.2389 | 163.4977 | 49.0632 | 5 |
| FacXa | 303.6389 | 124.1560 | 40.8894 | 1 |
| FGF-4 | 1769.7333 | 905.0823 | 51.1423 | 4 |
| FGF-9 | 1477.5389 | 1167.2341 | 78.9985 | 4 |
| Fibro | 1253.1389 | 526.5607 | 42.0193 | 3 |
| Hep1 | 113.0389 | 61.1009 | 54.0530 | 2 |
| Hep2 | 214.3333 | 294.1624 | 137.2453 | 4 |
| Hep2 | 247.2222 | 331.4338 | 134.0631 | 4 |
| Hep3 | 30.6056 | 77.0666 | 251.8058 | 4 |
| HGF | 574.6944 | 153.2148 | 26.6602 | 5 |
| IGF-1 | 420.5611 | 201.8463 | 47.9945 | 5 |
| IL-12 | 451.3333 | 192.1022 | 42.5633 | 2 |
| IL-2 | 1932.7166 | 587.9895 | 30.4230 | 4 |
| IFNg | 932.9611 | 693.7081 | 74.3555 | 4 |
| KGF | 1046.9611 | 382.2044 | 36.5061 | 4 |
| LF | 698.7500 | 157.7648 | 22.5782 | 1 |
| Lami | 1054.5667 | 507.7088 | 48.1438 | 3 |
| TNFα | 370.9944 | 428.1935 | 115.4177 | 4 |
| VEGF | 1874.2611 | 612.0246 | 32.6542 | 3 |
| Vitro | 4540.4277 | 2310.2854 | 50.8825 | 5 |

TABLE 3

| Factor | Parameters count |
|---|---|
| 1 | 3 |
| 2 | 2 |
| 3 | 5 |
| 4 | 11 |
| 5 | 4 |

Correlation Matrix.

The behavior of the factors was compared to determine whether correlations in binding patterns between factors could be detected. Table 4 displays symmetrical correlation matrix between the factors for the GMID-SAR analysis, and demonstrates that binding patterns between factors do not appear to be correlated. Thus, each factor provides a clear measure of the binding behavior of proteins within the relevant group, but the groups themselves do not shown correlated binding patterns.

TABLE 4

| | F1 | F2 | F3 | F4 | F5 |
|---|---|---|---|---|---|
| F1 | 1 | 0.335 | 0.29 | 0.309 | −0.468 |
| F2 | 0.335 | 1 | 0.578 | 0.613 | 0.152 |
| F3 | 0.29 | 0.578 | 1 | 0.796 | 0.414 |
| F4 | 0.309 | 0.613 | 0.796 | 1 | 0.498 |
| F5 | −0.468 | 0.152 | 0.414 | 0.498 | 1 |

Next, each object, or LS fraction, is characterized according to each factor, and the objects are separated into classes according to the characterization for each factor. Factor object classes from the profiling studies are summarized in Table 5 through Table 9, in which each table shows the results of classifying the objects, or LS fractions, according to each factor. These classifications are described in greater detail below, in which each factor (group of proteins) is described as yielding particular classifications of LS fractions. Each factor is defined as having a scale from its average minus its standard deviation to its average plus its standard deviation.

TABLE 5
Factor 1 - objects by classes

| Name | Value | Class |
|---|---|---|
| LS9 | −1.1752 | 1 |
| LS15 | −0.5800 | 1 |
| LS8 | −0.4985 | 1 |
| LS10 | −0.3856 | 1 |
| LS3 | −0.1942 | 1 |
| LS4 | −0.1324 | 1 |
| LS7 | −0.0977 | 1 |
| LS12 | 0.0083 | 1 |
| LS5 | 0.0178 | 1 |
| LS14 | 0.0207 | 1 |
| LS1 | 0.1315 | 1 |
| LS2 | 0.2239 | 1 |
| LS13 | 0.7796 | 2 |
| LS11 | 0.7861 | 2 |
| LS6 | 1.0957 | 2 |

TABLE 6
Factor 2 - objects by classes

| Name | Value | Class |
|---|---|---|
| LS7 | −0.5647 | 1 |
| LS3 | −0.4866 | 1 |
| LS5 | −0.4021 | 1 |
| LS9 | −0.3367 | 1 |
| LS8 | −0.2409 | 1 |
| LS12 | −0.1953 | 1 |
| LS4 | −0.0916 | 1 |
| LS1 | −0.0358 | 1 |
| LS2 | −0.0102 | 1 |
| LS6 | 0.0762 | 1 |
| LS10 | 0.0885 | 1 |
| LS14 | 0.1986 | 2 |
| LS13 | 0.5619 | 2 |
| LS11 | 0.5841 | 2 |
| LS15 | 0.8547 | 2 |

TABLE 7
Factor 3 - objects by classes

| Name | Value | Class |
|---|---|---|
| LS2 | −2.1081 | 1 |
| LS1 | −1.7456 | 1 |
| LS8 | −1.1909 | 1 |
| LS3 | −1.0412 | 1 |
| LS9 | −0.6608 | 1 |
| LS5 | −0.2916 | 1 |
| LS12 | −0.1432 | 1 |
| LS6 | 0.0856 | 2 |
| LS7 | 0.1658 | 2 |
| LS14 | 0.5181 | 2 |
| LS15 | 0.7530 | 2 |
| LS4 | 0.9143 | 2 |
| LS10 | 1.1110 | 2 |
| LS11 | 1.6672 | 2 |
| LS13 | 1.9664 | 2 |

TABLE 8
Factor 4 - objects by classes

| Name | Value | Class |
|---|---|---|
| LS2 | −2.6112 | 1 |
| LS1 | −2.5505 | 1 |
| LS3 | −2.4103 | 1 |
| LS5 | −2.1172 | 1 |
| LS4 | −1.4497 | 1 |
| LS6 | −1.4485 | 1 |
| LS8 | −0.8300 | 1 |
| LS7 | −0.6518 | 1 |
| LS9 | −0.6000 | 1 |
| LS15 | 0.1792 | 1 |
| LS10 | 1.4795 | 2 |
| LS14 | 1.6443 | 2 |
| LS12 | 1.9058 | 2 |
| LS13 | 4.7030 | 2 |
| LS11 | 4.7575 | 2 |

TABLE 9
Factor 5 - objects by classes

| Name | Value | Class |
|---|---|---|
| LS2 | −1.1210 | 1 |
| LS1 | −1.0225 | 1 |
| LS4 | −0.8552 | 1 |
| LS6 | −0.8385 | 1 |
| LS3 | −0.8255 | 1 |
| LS13 | −0.4222 | 1 |
| LS8 | −0.1801 | 1 |
| LS5 | −0.1732 | 1 |
| LS11 | 0.3271 | 2 |
| LS7 | 0.5368 | 2 |
| LS14 | 0.5687 | 2 |
| LS15 | 0.9236 | 2 |
| LS9 | 0.9270 | 2 |
| LS12 | 1.0276 | 2 |
| LS10 | 1.1273 | 2 |

Factor Parameters.

For each factor, the list of parameters with their weights in the factor (values between −1 and 1) is displayed. Parameters are sorted in descending order on weight's absolute value. The parameter lists for the factors for the GMID-SAR studies are summarized in Table 10 through Table 14. The factor parameter is a correlation of a parameter, or protein, in a particular group with the factor representing the group. The factor parameter is a measure of how closely the behavior of this parameter mirrors that of its corresponding group. The absolute value of the measure represents the strength of correlation, while the sign indicates that its behavior is similar to that of the group (positive values) or opposite to that of the group (negative values). The tables below show the similarity of behavior, in terms of binding patterns to LS fractions, for each member protein of a group, as compared to the behavior of the entire group.

TABLE 10
Factor 1 - Parameters count: 3

| Name | Weight |
|---|---|
| LF | 0.8865 |
| FacXa | 0.8394 |
| AFGF | 0.8194 |

TABLE 11
Factor 2 - Parameters count: 2

| Name | Weight |
|---|---|
| Hep1 | −0.8780 |
| IL-12 | 0.8780 |

TABLE 12
Factor 3 - Parameters count: 5

| Name | Weight |
|---|---|
| ApoE4 | 0.9877 |
| Fibro | 0.9597 |
| ApoE4 | 0.9531 |
| VEGF | 0.9349 |
| Lami | 0.8982 |

TABLE 13
Factor 4 - Parameters count: 11

| Name | Weight |
|---|---|
| IFNg | 0.9677 |
| KGF | 0.9594 |
| Hep2 | 0.9549 |
| Hep2 | 0.9482 |
| bFGF | 0.9443 |
| TNFa | 0.9379 |
| IL-2 | 0.9309 |
| FGF-9 | 0.8948 |
| FGF-4 | 0.8801 |
| ATIII | 0.7930 |
| Hep3 | 0.7606 |

TABLE 14
Factor 5 - Parameters count: 4

| Name | Weight |
|---|---|
| IGF-1 | −0.9216 |
| EGF | −0.9026 |
| Vitro | −0.8427 |
| HGF | −0.8333 |

B. GMID-SAR Results of Purified LS Preparation Fingerprinting.

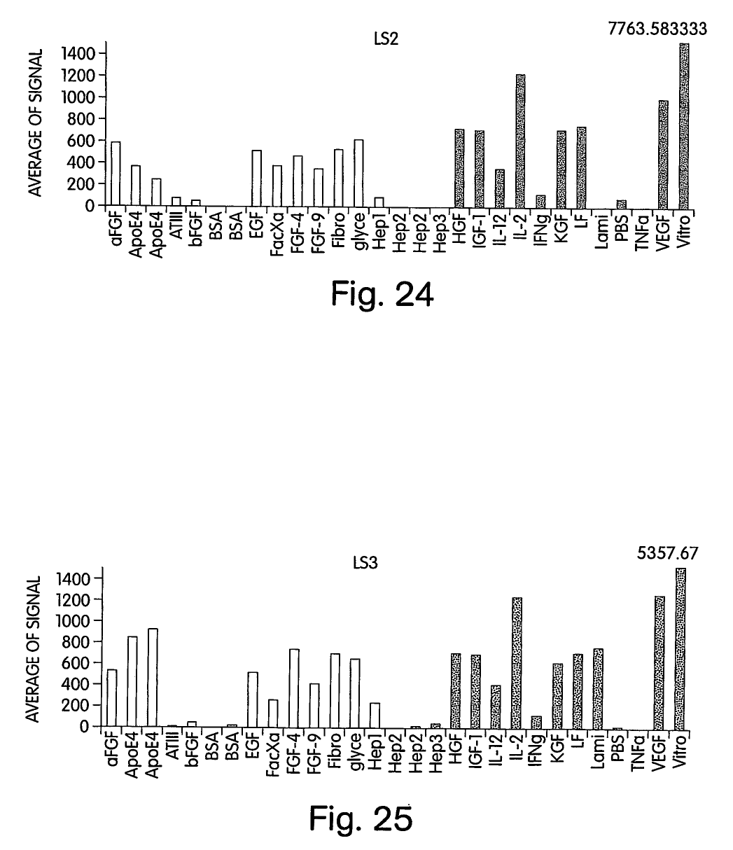

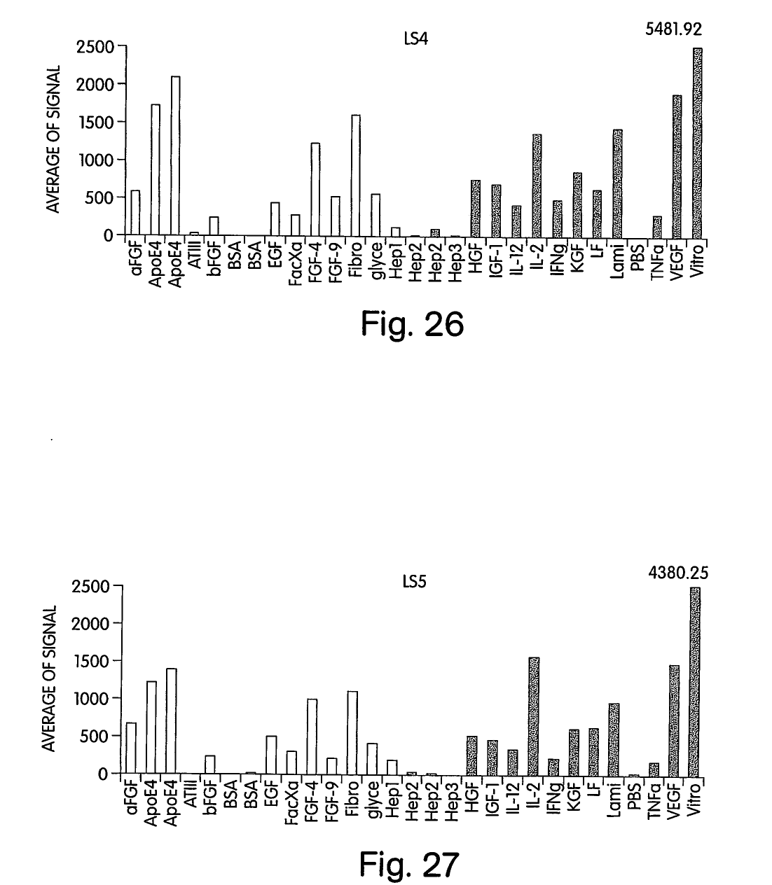

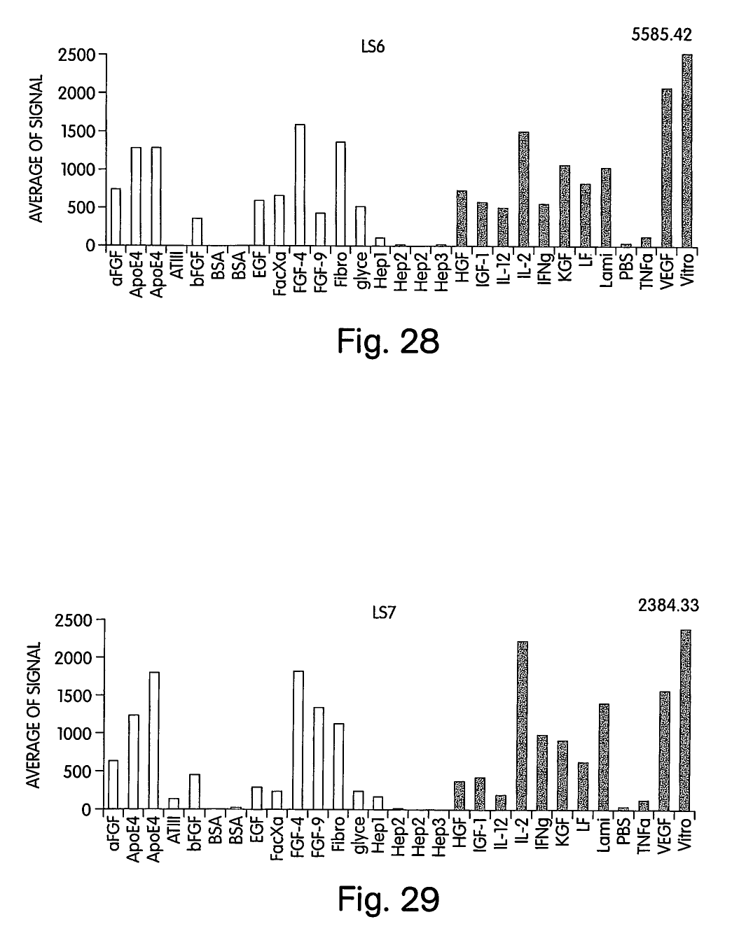

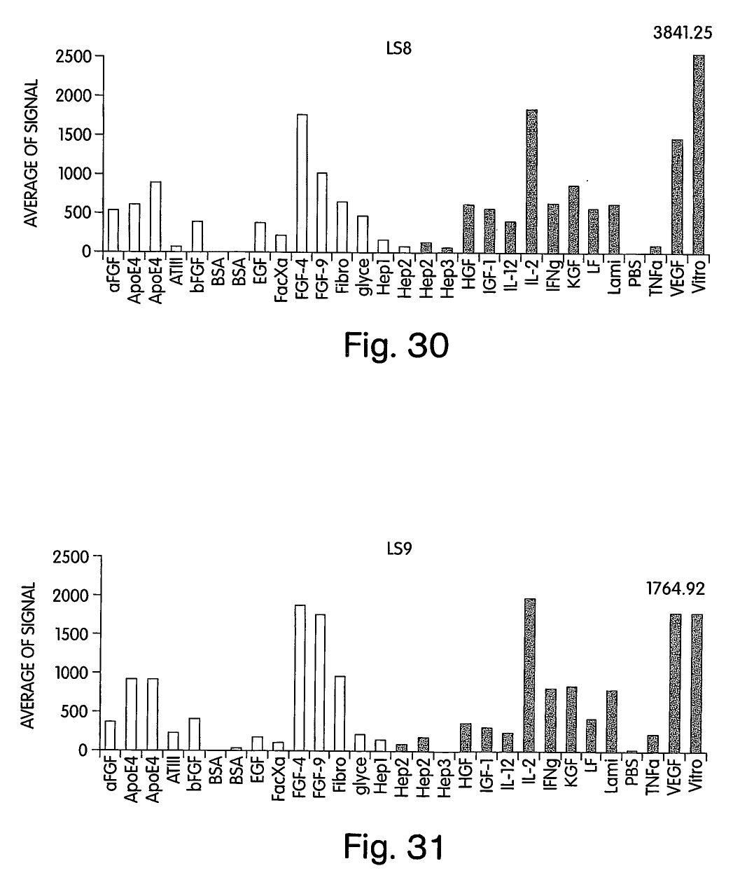

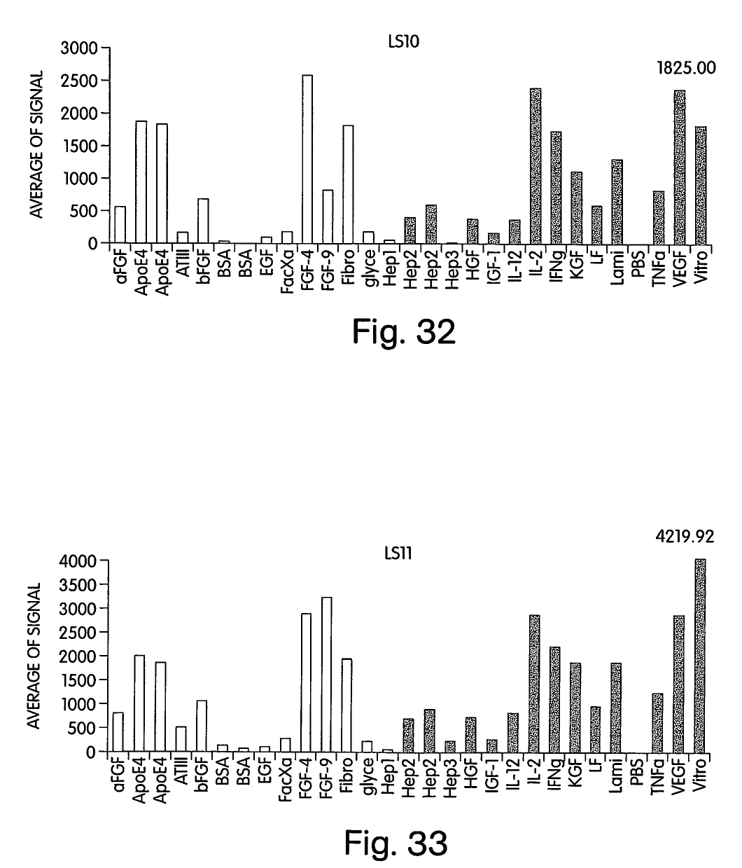

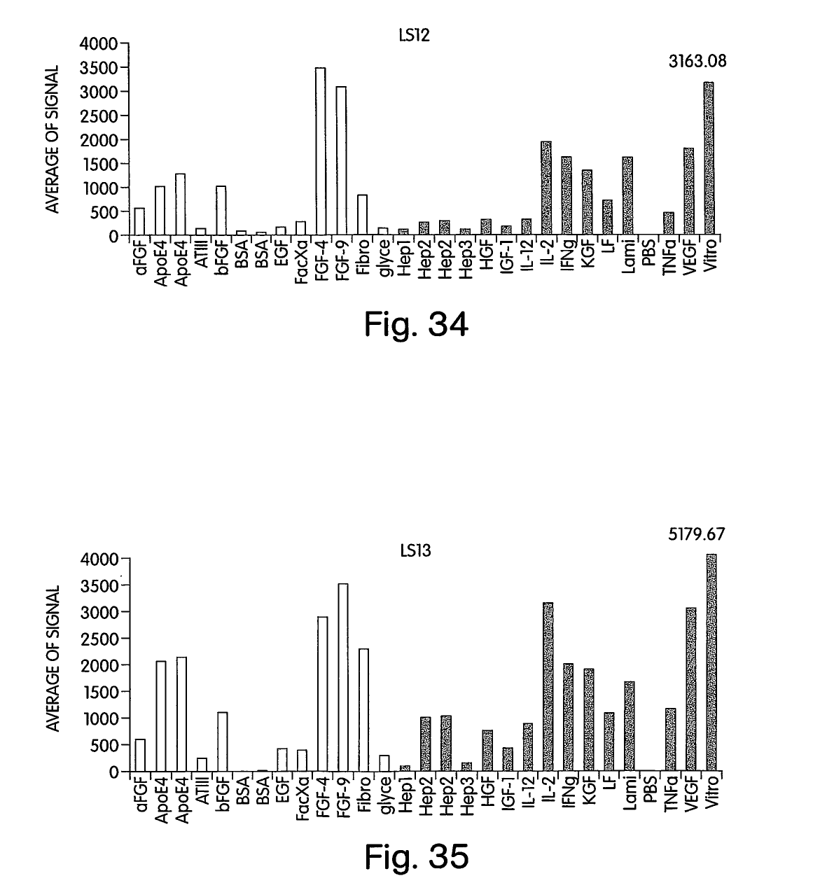

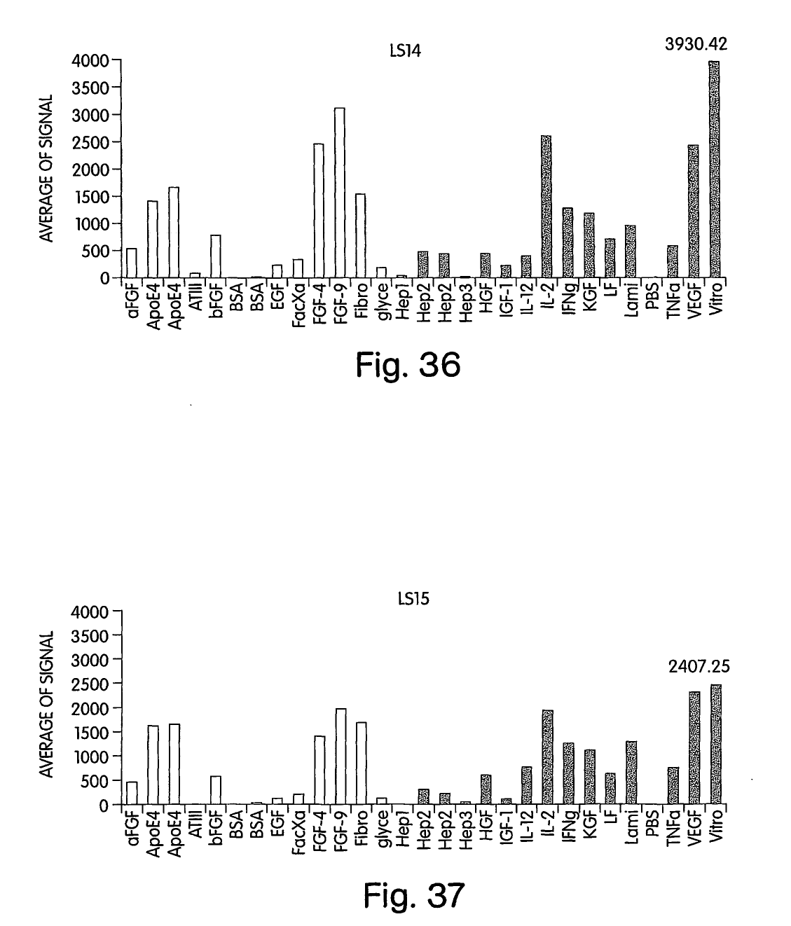

The unique binding fingerprint for each LS library fraction (LS1 through LS15) was determined as shown in FIG. 23 through FIG. 37. Individual fingerprints were assessed in order to determine the proteins that can discriminate between single LS-fractions or sets of fractions. These proteins were clustered to form differentiating protein groups, according to the previously described analysis. As summarized in Table 15, five well-defined groups of proteins were identified that differentiate between the fractions of the LS-library as well as heparin.

TABLE 15

| | | | Lingvo |
|---|---|---|---|
| LS-library | Groups | Heparin fragments | groups |
| High DP group | | High DP group | |
| EGF | 5 | EGF | 5 |
| IGF-1 | 5 | IGF-1 | 5 |
| Vitronectin | 5 | Vitro | 5 |
| | | HGF | 5 |
| | | Hep-2 | 4 |
| | | Fibronectin | 3 |
| | | Factor Xa | 1 |
| High + Low DP group | | DP10 and DP12 group | |
| aFGF | 1 | aFGF | 1 |
| hmLF | 1 | hmLF | 1 |
| FacXa | 1 | IL-12 | 2 |
| Laminin | 3 | | |
| HGF | 5 | | |
| Low DP group | | Low DP group | |
| FGF-9 | 4 | FGF-9 | 4 |
| bFGF | 4 | bFGF | 4 |
| FGF-4 | 4 | FGF-4 | 4 |
| TNFa | 4 | TNFa | 4 |
| IFN-gamma | 4 | | |
| ATIII | 4 | | |
| IL-2 | 4 | | |
| Heparanase-2 | 4 | | |
| LS4&10, LS11&13 | | All the same group | 3 |
| group | 3 | VEGF | 3 |
| VEGF | 3 | ApoE4 | 3 |
| ApoE4 | 3 | Laminin | 4 |
| Fibronectin | | IL-2 | |
| LS11 and LS13 group | 2 | | |
| IL-12 | 4 | | |
| KGF | | | |

The first group isolates a cluster of 4 distinct LS-fractions, e.g., LS6, LS11, LS13, and LS9, that were located as a result of clustering the LS fractions according to the binding behavior with each group of proteins, as described above. The LS11 and LS13 fractions show overlapping binding features with this protein group. The LS9 fraction shows a binding pattern opposite to that of LS6.

The second group isolates 3 distinct LS-fractions, e.g., LS11, LS13, LS15. The LS11 and LS13 fractions show very close binding features with this protein group.

The third group isolates 8 distinct LS-fractions, e.g., LS1, LS2, LS3, LS8, LS4, LS10, LS 11, and LS13. The LS11 and LS13 fractions show very close binding features with this protein group. The LS4 and LS 10 fractions show very close binding features with this protein group. The LS1 and LS2 fractions show very close binding features with this protein group, which are opposite to the binding patterns of LS11 and LS13 fractions. The LS3 and LS8 fractions show very close binding features with this protein group, which are opposite to the binding patterns of LS4 and LS8 fractions.

With the exception of LS15 fraction, the fourth group distinguishes best between fragments with high and low DP (molecular weight). The LS11 and LS 13 fractions show overlapping binding features with this fourth protein group. Interestingly this shows a correlation between an external characteristic of a subpopulation of oligosaccharides, or LS fraction, and the clusters determined above. High and low DP is an example of an external characteristic, in that it is not directly related to, or derived from, binding of the proteins to the LS fractions.

The fifth group also distinguishes between fragments with high and low DP, but less accurately than the fourth group. The LS7 and LS13 fractions are exceptions. This is the only group, that does not recognize LS11 and LS13 as fractions with related binding patterns.

In a secondary analysis, proteins with identical or very similar binding patterns were grouped. These groups were compared with the five protein groups that were found according to the primary analysis by the Lingvo software program, as described above. The groups formed with the LS-library and heparin fragments are very similar. The groups depicted from binding with the LS-library are mostly correlated to the size of the LS fractions. Thus, the majority of these HBP show specificity towards the size of the fragment and not to structural differences. However, recognition of distinct fragments and/or distinction between fragments with similar length were also evident between, e.g., the HP10 and HP12 group; LS4&10 and LS 11&13 group; the LS11 and LS13; as well as protein groups 1, 2 and 3 from the primary analysis.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of producing a purified laminarin or laminarin sulphate fragment, the method comprising
providing a population of laminarin or laminarin sulphate fragments;
separating said population of fragments, thereby forming a plurality of subpopulations of fragments;
identifying one or more subpopulations comprising fragments including 8 to 30 glucose subunits;
separating said subpopulations, thereby forming a plurality of sub-subpopulations of fragments; and
identifying one or more sub-subpopulations, thereby producing a purified laminarin or laminarin sulphate fragment.

2. The method of claim 1, wherein said population of fragments is separated on a on a size exclusion chromatography column.

3. The method of claim 1, wherein said subpopulation of fragments are separated on a size exclusion chromatography column.

4. The method of claim 1, wherein said subpopulation of fragments are separated on a size exclusion chromatography column.

5. The method of claim 1, wherein said providing said population of laminarin or laminarin sulphate fragments further comprises partially hydrolyzing a starting population of laminarin or laminarin sulfate molecules, thereby providing a population of laminarin or laminarin sulphate fragments.

6. The method of claim 5, wherein said hydrolysis is with laminarinase.

7. The method of claim 1, wherein said method further includes altering the sulphation state of said population of laminarin fragments prior to separating said population.

8. The method of claim 7, wherein said method includes increasing the sulphation state of said population of laminarin fragments.

9. The method of claim 5, wherein said method further includes altering the sulphation state of said population of laminarin fragments prior to or subsequent to separating said population.

10. The method of claim 9, wherein said method includes increasing the sulphation state of said population of laminarin fragments.

11. A method of producing a library of oligosaccharides, the method comprising
providing a population of oligosaccharides;
separating said population of oligosaccharides by size, thereby forming a plurality of subpopulations of fragments of a plurality of different sizes;
contacting each subpopulation of oligosaccharides with a first saccharide-binding agent and a second saccharide-binding agent;
determining whether the first saccharide-binding agent and second saccharide binding agent bind each subpopulation of oligosaccharides; and identifying a fingerprint for each subpopulation of oligosaccharides from said determining whether the first and second saccharide-binding agents bind to each subpopulation of fragments, such that a plurality of fingerprints is generated;
thereby producing a producing a library of oligosaccharides.

12. The method of claim 11, wherein the population of oligosaccharides is selected from the group consisting of laminarin, laminarin sulphate, heparin, and heparan sulphate.

13. The method of claim 11, further comprising:
clustering said plurality of subpopulations of oligosaccharides according to said fingerprints to form a plurality of clusters.

14. The method of claim 13, further comprising:
correlating each cluster with an external characteristic of at least one subpopulation of oligosaccharides, wherein said external characteristic is external to binding of said at least one of the first saccharide-binding agent and second saccharide binding agent to each subpopulation in each cluster.

15. The method of claim 13, further comprising contacting a second subpopulation of oligosaccharides with the first saccharide-binding agent and the second saccharide-binding agent; and
determining whether the first saccharide-binding agent and second saccharide binding agent bind said second subpopulation of oligosaccharides;
thereby generating said fingerprint.

16. The method of claim 13, wherein the fingerprint is determined by contacting the first subpopulation of oligosaccharides with at least five saccharide binding agents and determining whether said at least five saccharide binding agents bind to said first subpopulation of oligosaccharides.

17. The method of claim 13, wherein the fingerprint is determined by contacting the first subpopulation of oligosaccharides with at least 15 saccharide binding agents and determining whether said at least 15 saccharide binding agents bind to said first subpopulation of oligosaccharides.

18. The method of claim 13, wherein determining binding of the first and second saccharide-agent comprises:
providing a surface comprising at least one first saccharide-binding agent attached to a predetermined location on said surface;
contacting said surface with said subpopulation of oligosaccharides under conditions allowing for the formation of a first complex between the first saccharide-binding agent and said subpopulation;
contacting said surface with at least one second saccharide-binding agent under conditions allowing for formation of a second complex between the first complex and the second saccharide-binding agent; and
identifying the first saccharide-binding agent and second saccharide-binding agent in the second complex.

19. The method of claim 18, wherein the second saccharide-binding agent further comprises a detectable label.

20. The method of claim 18, wherein said detectable label is selected from the group consisting of a chromogenic label, a radiolabel, a fluorescent label, and a biotinylated label.

22. The method of claim 21, wherein the separation is by size exclusion chromatography.

23. The method of claim 13, wherein the first saccharide binding agent is selected from the group consisting of a lectin, a saccharide-cleaving enzyme, an antibody to a saccharide, aFGF, ATIII, bFGF, EGF, FacXa, FGF4, FGF9, Fibronectin, IFN-gamma, IGF, IL2, KGF, hmLF, VEGF, Vitronectin, Lami, ApoE4, Heparanase 1, Heparanase 2, Heparanase 3, HGF, IL-12, and TNFα.

24. The method of claim 13, wherein the second saccharide binding agent is selected from the group consisting of a lectin, a polysaccharide-cleaving or modifying enzyme, an antibody to a saccharide, AFGF, ATIII, bFGF, EGF, FacXa, FGF4, FGF9, Fibronectin, IFN-gamma, IGF, IL2, KGF, hmLF, VEGF, Vitronectin, Lami, ApoE4, Heparanase 1, Heparanase 2, Heparanase 3, HGF, IL-12, and TNFα.

25. The method of claim 11, wherein said providing population of oligosaccharides comprises:
digesting said population of oligosaccharides with a saccharide-cleaving agent.

26. The method of claim 25, wherein said saccharide cleaving agent is heparanase or laminarinase.

27. The method of claim 11, wherein said fingerprint and second fingerprint comprises information for at least five saccharide-binding agents.

28. The method of claim 11, wherein said fingerprint and second fingerprint comprises information for at least 10 saccharide-binding agents.

29. The method of claim 11, wherein said fingerprint and second fingerprint comprises information for at least 15 saccharide-binding agents.

30. The method of claim 11, wherein said fingerprint and second fingerprint comprises information for at least 25 saccharide-binding agents.

31. An oligosaccharide library comprising a plurality of oligosaccharide subpopulations, wherein each of said subpopulations have been characterized with a known fingerprint.

32. The library of claim 31, wherein said oligosaccharide is laminarin.

33. The library of claim 31, wherein each of said subpopulations is separated by size.

34. The library of claim 33, wherein said plurality of subpopulations is obtained by cleaving said oligosaccharide with a cleaving agent.

35. The library of claim 31, wherein said fingerprint comprises information for at least five saccharide-binding agents.

36. The library of claim 31, wherein said fingerprint comprise information for at least 10 saccharide-binding agents.

37. The library of claim 31, wherein said fingerprint comprises information for at least 15 saccharide-binding agents.

38. The library of claim 31, wherein said fingerprint comprises information for at least 25 saccharide-binding agents.

39. A method of producing a purified laminarin or laminarin sulphate fragment, the method comprising
providing a population of laminarin or laminarin sulphate fragments;
separating said population of fragments, thereby forming a plurality of subpopulations of fragments;
identifying one or more subpopulations comprising fragments including 8 to 30 glucose subunits;
separating said subpopulations, thereby forming a plurality of sub-subpopulations of fragments; and
identifying one or more sub-subpopulations, thereby producing a purified laminarin or laminarin sulphate fragment.

40. The method of claim 39, wherein said population of fragments is separated on a on a SEC-P10 column.

41. The method of claim 39, wherein said subpopulation of fragments are separated on a SEC-P10 column.

42. The method of claim 40, wherein said subpopulation of fragments are separated on a SEC-P10 column.

43. The method of claim 38, wherein said population of laminarin or laminarin sulphate is a population of laminarin or laminarin sulphate molecules comprising a plurality of partially hydrolyzed laminarin molecules.

44. The method of claim 43, wherein said hydrolysis is with laminarinase.

45. The method of claim 39, wherein said method further includes altering the sulphation state of said population of laminarin fragments prior to separating said population.

46. The method of claim 45, wherein said method includes increasing the sulphation state of said population of laminarin fragments.

47. The method of claim 43, wherein said method further includes altering the sulphation state of said population of laminarin fragments prior to separating said population.

48. The method of claim 47, wherein said method includes increasing the sulphation state of said population of laminarin fragments.
